(19) United States
(12) Patent Application Publication
(10) Pub. No.: US 2026/0204786 A1
(43) Pub. Date: Jul. 16, 2026

(54) RADIO WAVE IRRADIATION DEVICE

(71) Applicant: Japan Display Inc., Tokyo (JP)

(72) Inventors: Kazuki MATSUNAGA, Tokyo (JP); Koichi IGETA, Tokyo (JP); Shinichiro OKA, Tokyo (JP); Mitsutaka OKITA, Tokyo (JP); Daiichi SUZUKI, Tokyo (JP)

(73) Assignee: Japan Display Inc., Tokyo (JP)

(21) Appl. No.: 19/564,190

(22) Filed: Mar. 12, 2026

Related U.S. Application Data
(63) Continuation of application No. PCT/JP2024/032745, filed on Sep. 12, 2024.

(30) Foreign Application Priority Data
Sep. 19, 2023 (JP) 2023-151481

(51) Int. Cl. H01Q 9/04; H01Q 1/52; H01Q 15/14; H01Q 17/00

(52) U.S. Cl. CPC H01Q 9/0407; H01Q 1/526; H01Q 15/14; H01Q 17/007

(57) ABSTRACT

A radio wave irradiation device includes: a radio wave emission source configured to emit radio waves; and a radio wave reflecting device provided on a side wall of a space in which an object to be heated is accommodated, the radio wave reflecting device being configured to reflect the radio waves emitted from the radio wave emission source, wherein the radio wave reflecting device includes a plurality of reflecting elements arranged in at least one direction, and the reflecting elements includes: a patch electrode; a counter electrode facing the patch electrode; and a liquid crystal layer disposed between the patch electrode and the counter electrode.

### CROSS-REFERENCE TO RELATED APPLICATIONS

This application is a Continuation of International Patent Application No. PCT/JP2024/032745, filed on Sep. 12, 2024, which claims the benefit of priority to Japanese Patent Application No. 2023-151481, filed on Sep. 19, 2023, the entire contents of each are incorporated herein by reference.

### FIELD

An embodiment of the present invention relates to a radio wave irradiation device that can control the propagation direction of a reflected radio wave.

### BACKGROUND

For example, heating devices that heat an object to be heated by irradiating the object to be heated with microwaves, such as microwave ovens, are widely used. In order to efficiently and uniformly heat the object to be heated, a microwave oven uses a mechanism for rotating a table on which the object to be heated is placed or an antenna that emits microwaves.

However, even in a microwave oven equipped with such a mechanism, there may be regions where the microwave intensity is high or low due to the shape of a heating chamber. To suppress the occurrence of such regions, a microwave oven in which a phase control plate is provided on a side wall of the heating chamber has been disclosed (for example, International patent publication No. 2018/235161). The reflection phase of the microwaves at the side wall is controlled by changing the capacitance value of the phase control plate. A technology has been developed that controls this reflection phase to efficiently and uniformly heat the object to be heated.

### SUMMARY

A radio wave irradiation device according to an embodiment of the present invention includes a radio wave emission source configured to emit radio waves; and a radio wave reflecting device provided on a side wall of a space in which an object to be heated is accommodated, the radio wave reflecting device being configured to reflect the radio waves emitted from the radio wave emission source, wherein the radio wave reflecting device includes a plurality of reflecting elements arranged in at least one direction, and the reflecting elements includes: a patch electrode; a counter electrode facing the patch electrode; and a liquid crystal layer disposed between the patch electrode and the counter electrode.

### BRIEF DESCRIPTION OF DRAWINGS

FIG. 1 is a cross-sectional view and a functional block diagram showing an overview of a radio wave heating device according to an embodiment of the present invention.

FIG. 2 is a cross-sectional view showing an overview of a radio wave reflecting device of a radio wave heating device according to an embodiment of the present invention.

FIG. 3 is a cross-sectional view showing a mounting structure of a radio wave reflecting device in a radio wave heating device according to an embodiment of the present invention.

FIG. 4A is a plan view of a reflecting surface unit cell used in a radio wave reflecting device according to an embodiment of the present invention.

FIG. 4B shows a cross-sectional structure of a reflecting surface unit cell used in a radio wave reflecting device according to an embodiment of the present invention.

FIG. 5A is a diagram showing a state in which no voltage is applied between a patch electrode and a ground electrode in a reflecting surface unit cell used in a radio wave reflecting device according to an embodiment of the present invention.

FIG. 5B is a diagram showing a state in which a voltage is applied between a patch electrode and a ground electrode in a reflecting surface unit cell used in a radio wave reflecting device according to an embodiment of the present invention.

FIG. 6 shows the simulation results of a relationship between a thickness of a liquid crystal layer and a phase change of a reflected wave in a radio wave reflecting device according to an embodiment of the present invention.

FIG. 7 is a diagram showing a configuration of a radio wave reflecting device according to an embodiment of the present invention.

FIG. 8 is a diagram schematically showing a change in the propagation direction of a reflected wave by a radio wave reflecting device according to an embodiment of the present invention.

FIG. 9 is a diagram showing a configuration of a radio wave reflecting device according to an embodiment of the present invention.

FIG. 10 shows a cross-sectional structure of a reflecting surface unit cell in a radio wave reflecting device according to an embodiment of the present invention.

FIG. 11 is a cross-sectional view showing an overview of a radio wave reflecting device of a radio wave heating device according to an embodiment of the present invention.

FIG. 12 is a plan view showing an overview of a patch electrode of a radio wave heating device according to an embodiment of the present invention.

### DESCRIPTION OF EMBODIMENTS

Hereinafter, embodiments of the present invention will be described with reference to the drawings and the like. However, the present invention can be implemented in many different aspects, and should not be construed as being limited to the description of the embodiments exemplified below. The width, thickness, shape, and the like of each part may be schematically represented in comparison with the actual embodiments in order to clarify the description, but the drawings are merely examples and do not limit the interpretation of the present invention. In the present specification and the drawings, elements similar to those described above with respect to the above-described figures are denoted by the same reference signs (or reference signs denoted by a, b, and the like) and detailed description thereof may be omitted as appropriate. Furthermore, the terms “first” and “second” with respect to the respective elements are convenient signs used to distinguish the respective elements, and do not have any further meaning unless otherwise specified.

In the present specification, a member or region is “on (or under)” another member or region, including, without limitation, when it is directly above (or below) another member or region, but also when it is above (or below) another member or region. That is, the above expressions include the case where another component is included between a member or region and another member or region.

In the present specification, the expressions “α includes A, B or C,” “α includes any of A, B and C,” and “α includes one selected from a group consisting of A, B, and C” do not exclude the case where α includes a plurality of combinations of A to C unless otherwise specified. Furthermore, these expressions do not exclude the case where α includes other elements.

In addition, the following embodiments may be combined with each other as long as no technical contradiction is caused.

One of the objectives of an embodiment of the present invention is to provide a radio wave irradiation device with a novel configuration that can irradiate an object with radio waves efficiently and uniformly.

### 1. First Embodiment

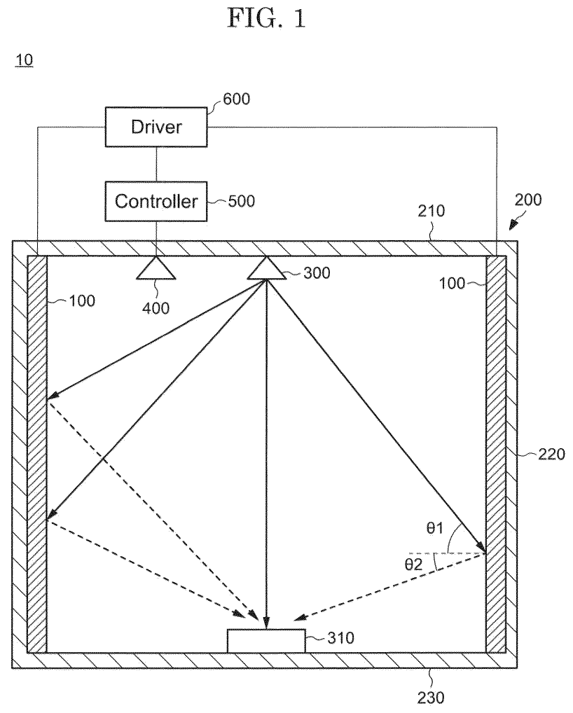

A radio wave heating device 10 according to an embodiment of the present invention will be described with reference to FIG. 1 to FIG. 10. In the following embodiments, a radio wave heating device that heats an object by irradiating the object with radio waves will be described as an example of a radio wave irradiation device, but the present invention is not limited to a radio wave heating device. For example, an embodiment of the present invention can be applied to a device that irradiates an object with radio waves for purposes other than heating the object.

### 1-1. Radio Wave Heating Device 10

FIG. 1 is a cross-sectional view and a functional block diagram showing an overview of a radio wave heating device according to an embodiment of the present invention. As shown in FIG. 1, the radio wave heating device 10 includes a radio wave reflecting device 100, a heating chamber 200, a radio wave emission source 300, a sensor 400, a control circuit 500, and a drive circuit 600. The control circuit 500 and the drive circuit 600 in FIG. 1 are illustrated to show their connections to other members and do not indicate that the control circuit 500 and the drive circuit 600 are arranged outside the heating chamber 200.

The heating chamber 200 includes a ceiling portion 210, a side wall 220, and a bottom portion 230. For example, when the planar shape of the ceiling portion 210 and the bottom portion 230 is rectangular, four side walls 220 are provided corresponding to the sides of the rectangle. Among the four side walls 220, one side wall includes an openable door.

The radio wave reflecting device 100 is provided on the side wall 220. The radio wave reflecting device 100 reflects radio waves emitted from the radio wave emission source 300, which will be explained later, in a desired direction. That is, the radio wave reflecting device 100 can reflect radio waves so that an incident angle (θ1) of radio waves incident on the radio wave reflecting device 100 and a reflection angle (θ2) of radio waves reflected by the radio wave reflecting device 100 are different. The radio wave reflecting device 100 changes the phase of the radio waves incident on the radio wave reflecting device 100. Due to the phase change, the direction in which the radio waves are reflected is determined. The radio wave reflecting device 100 is provided on the left and right side walls 220 when the radio wave heating device 10 is viewed with the door at the front. However, the radio wave reflecting device 100 may be provided on the rear side wall 220 or on the door.

The radio wave emission source 300 is provided on the ceiling portion 210 to emit radio waves toward the side wall 220 and the bottom portion 230. The frequency of the radio waves emitted by the radio wave emission source 300 is 300 MHz or higher and 300 GHz or lower. The radio waves are known as microwaves. For example, the frequency of microwaves used in a microwave oven is 2.4 GHz. However, the radio waves emitted by the radio wave emission source 300 are not limited to microwaves and may have a frequency below 300 MHz or above 300 GHz. The size and pitch of a patch electrode 108 are determined according to the frequency of the radio waves. The radio wave emission source 300 may be an antenna, a magnetron, and a waveguide, but it is not limited to these configurations.

An object to be heated 310 is accommodated in the space defined by the ceiling portion 210, the side wall 220, and the bottom portion 230. In FIG. 1, the object to be heated 310 is arranged on the bottom portion 230. The object to be heated 310 can be arranged directly on the bottom portion 230 or on a stage provided on the bottom portion 230.

The sensor 400 is provided on the ceiling portion 210 to detect the position of the object to be heated 310. The sensor 400 may be equipped with a temperature detection function in addition to a position detection function. That is, the sensor 400 may detect regions with high and low temperatures within the object to be heated 310. The sensor 400 may also be provided on the side wall 220 or the bottom portion 230.

The control circuit 500 is connected to the sensor 400. The detection information of the object to be heated 310 detected by the sensor 400 is transmitted to the control circuit 500. The control circuit 500 calculates position information (or position information and temperature information) of the object to be heated 310 in the heating chamber 200 based on the detection information received from the sensor 400.

The drive circuit 600 is connected to the control circuit 500 and the radio wave reflecting device 100. The drive circuit 600 drives the radio wave reflecting device 100 based on the position information calculated by the control circuit 500. That is, the control circuit 500 controls the drive circuit 600 based on the position information of the object to be heated 310 detected by the sensor 400. Specifically, the control circuit 500 controls the drive circuit 600 so that the radio waves emitted from the radio wave emission source 300 toward the radio wave reflecting device 100 and reflected by the radio wave reflecting device 100 are directed toward the object to be heated 310 detected by the sensor 400. For example, as shown in FIG. 1, for the radio waves emitted from the radio wave emission source 300 toward the radio wave reflecting device 100 on the right side of the radio wave reflecting device 100 in FIG. 1, the drive circuit 600 is controlled by the control circuit 500 so that the incident angle θ1 and the reflection angle θ2 with respect to the radio wave reflecting device 100 are different.

### 1-2. Radio Wave Reflecting Device 100

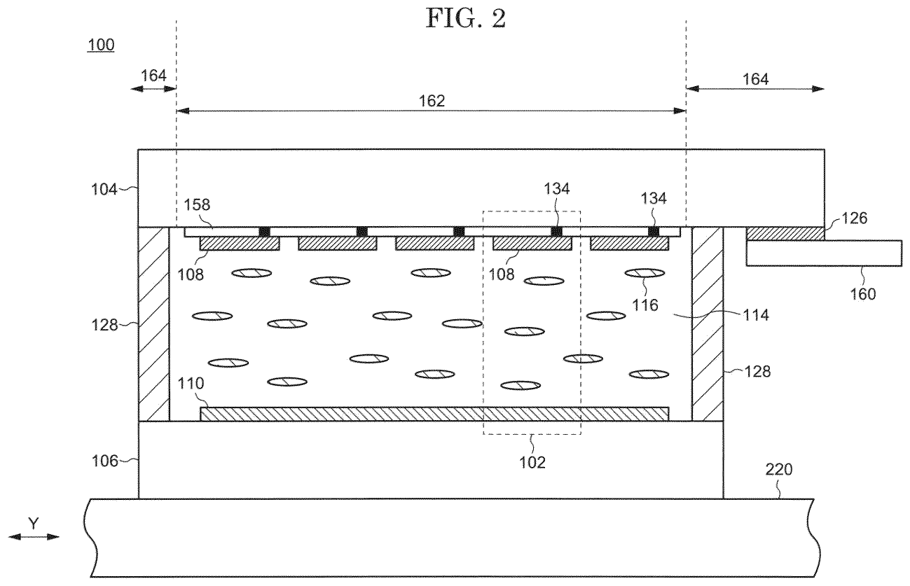

FIG. 2 is a cross-sectional view showing an overview of a radio wave reflecting device of a radio wave heating device according to an embodiment of the present invention. As shown in FIG. 2, the radio wave reflecting device 100 is provided with a plurality of reflecting elements (reflecting surface unit cells 102). The plurality of reflecting surface unit cells 102 is arranged in at least one direction. In FIG. 2, the plurality of reflecting surface unit cells 102 is arranged in a Y-axis direction. The radio wave reflecting device 100 includes a dielectric substrate 104, a counter substrate 106, the patch electrode 108, a ground electrode (counter electrode) 110, a liquid crystal layer 114, a sealing material 128, a switching element 134, a terminal portion 126, and a flexible printed circuit substrate (FPC) 160. The liquid crystal layer 114 contains a liquid crystal molecule 116. A passivation layer 158 is provided between the patch electrode 108 and the dielectric substrate 104. Although details will be described later, if the radio wave reflecting device 100 is a dual-axis reflection control device, the radio wave reflecting device includes the switching element 134, but if the radio wave reflecting device 100 is a single-axis reflection control device, the radio wave reflecting device 100 may not include the switching element 134.

The reflecting surface unit cell 102 includes at least the patch electrode 108, the ground electrode 110, the liquid crystal layer 114, and the switching element 134. The patch electrode 108 is provided individually for each reflecting surface unit cell 102. The patch electrode 108 is provided on the dielectric substrate 104 side. The ground electrode 110 faces the patch electrode 108 and is commonly provided for the plurality of reflecting surface unit cells 102. The ground electrode 110 is provided on the counter substrate 106 side.

The counter substrate 106 is arranged closer to the side wall 220 than the dielectric substrate 104. In other words, the dielectric substrate 104 is provided on an inner side of the heating chamber 200 or closer to the radio wave emission source 300 than the counter substrate 106. Similarly, the patch electrode 108 is provided closer to the radio wave emission source 300 than the ground electrode 110. Although a configuration in which the counter substrate 106 is provided to be in contact with the side wall 220 is exemplified in FIG. 2, the present invention is not limited to this configuration. For example, another member may be provided between the counter substrate 106 and the side wall 220.

The liquid crystal layer 114 is provided between the patch electrode 108 and the ground electrode 110. An alignment of the liquid crystal molecule 116 contained in the liquid crystal layer 114 is controlled by a voltage supplied to the patch electrode 108 and the ground electrode 110. The sealing material 128 is provided to surround the periphery of the counter substrate 106. In other words, the liquid crystal layer 114 is sealed with the sealing material 128. The patch electrode 108 and the ground electrode 110 are provided in a region surrounded by the sealing material 128.

The radio wave reflecting device 100 is divided into a radio wave reflecting region 162 and a peripheral region 164 surrounding the radio wave reflecting region 162. The patch electrode 108 and the ground electrode 110 are arranged in the radio wave reflecting region 162. The radio wave incident on the radio wave reflecting device 100 from the dielectric substrate 104 side is reflected by the radio wave reflecting region 162. When the radio wave is reflected, the propagation direction of the reflected radio wave can be controlled by controlling the voltage supplied between the patch electrode 108 and the ground electrode 110 and controlling the alignment of the liquid crystal molecule 116. Although not shown, a part of the drive circuit 600 is arranged in the peripheral region 164.

The switching element 134 is connected to the patch electrode 108. The switching element 134 is provided closer to the radio wave emission source 300 than the patch electrode 108. The switching element 134 is driven by the drive circuit 600 (see FIG. 1). The alignment of the liquid crystal molecule 116 is controlled according to the driving state of the switching element 134. Although details will be described later, the alignment of the liquid crystal molecule 116 is controlled so that the phase of the radio wave reflected by the radio wave reflecting device 100 is controlled. By controlling the phase of this radio wave, the propagation direction of the reflected radio wave is controlled.

The terminal portion 126 is provided at the end portion of the dielectric substrate 104. The terminal portion 126 may be formed in the same layer as the patch electrode 108. The terminal portion 126 may be in the same layer as a part or all of the conductive layers forming the switching element 134. The terminal portion 126 is connected to the switching element 134 via a wiring. The FPC 160 is connected to the terminal portion 126. The drive circuit 600 drives the switching element 134 in response to a control signal input from the outside via the FPC 160.

### 1-3. Mounting Structure of Radio Wave Reflecting Device 100

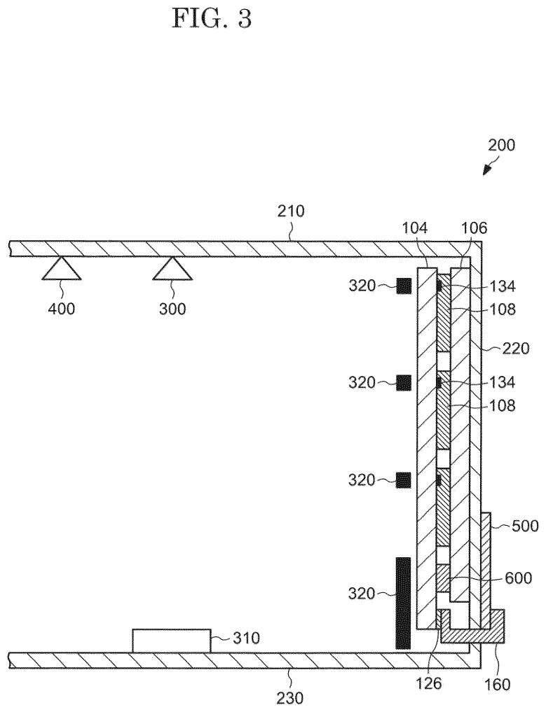

FIG. 3 is a cross-sectional view showing a mounting structure of a radio wave reflecting device in a radio wave heating device according to an embodiment of the present invention. For convenience of explanation, FIG. 3 shows only the dielectric substrate 104, the counter substrate 106, the patch electrode 108, the terminal portion 126, the switching element 134, and the FPC 160 of the radio wave reflecting device 100 of FIG. 2. In addition to the above configuration, FIG. 3 shows the drive circuit 600 provided on the dielectric substrate 104. The drive circuit 600 is provided in the peripheral region 164 in the same manner as the terminal portion 126. For example, the drive circuit 600 is mounted on the dielectric substrate 104 in the form of Chip on Glass (COG).

As shown in FIG. 3, a radio wave shielding member 320 for shielding the radio wave emitted from the radio wave emission source 300 is provided between the terminal portion 126 and the radio wave emission source 300, between the switching element 134 and the radio wave emission source 300, and between the drive circuit 600 and the radio wave emission source 300. The radio wave shielding member 320 is provided closer to t he radio wave emission source 300 than the terminal portion 126, the switching element 134, and the drive circuit 600. Since the radio wave emitted from the radio wave emission source 300 is shielded by the radio wave shielding member 320, it is possible to suppress adverse effects such as heat generation in the terminal portion 126, the switching element 134, and the drive circuit 600 when the radio waves are irradiated. Instead of the radio wave shielding member 320, a radio wave absorbing member for absorbing radio waves may be used.

Although a configuration in which the radio wave shielding member 320 is provided for all of the terminal portion 126, the switching element 134, and the drive circuit 600 is exemplified in FIG. 3, the embodiment according to the present invention is not limited to this configuration. The radio wave shielding member 320 may be provided for at least some of the members of the terminal portion 126, the switching element 134, and the drive circuit 600. For example, if the switching element 134 is not adversely affected by the radio wave emitted from the radio wave emission source 300, the radio wave shielding member 320 for the switching element 134 may be omitted.

As shown in FIG. 3, the FPC 160 penetrates through the side wall 220 and is drawn out to the outside of the heating chamber 200. The FPC 160, drawn out to the outside of the heating chamber 200, is connected to the control circuit 500 provided outside the heating chamber 200. The control circuit 500 and the drive circuit 600 are electrically connected by the wiring connected to the FPC 160 and the terminal portion 126.

In the case of the dual-axis reflection control described later, since the switching element 134 is provided in the radio wave reflecting region 162, the radio wave shielding member 320 is provided at a position corresponding to the switching element 134 as described above. On the other hand, in the case where the switching element 134 is not provided in the radio wave reflecting region 162, as in the single-axis reflection control described later, the radio wave shielding member 320 is provided at a position corresponding to the terminal portion 126 and the drive circuit 600 in the peripheral region 164, and the radio wave shielding member 320 may not be provided in the radio wave reflecting region 162.

### 1-4. Reflecting Surface Unit Cell

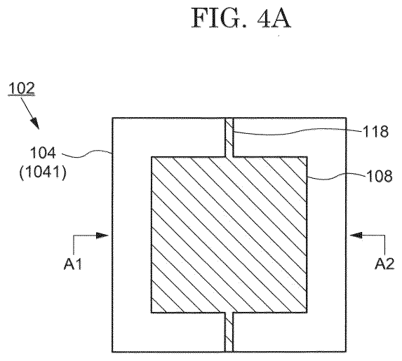

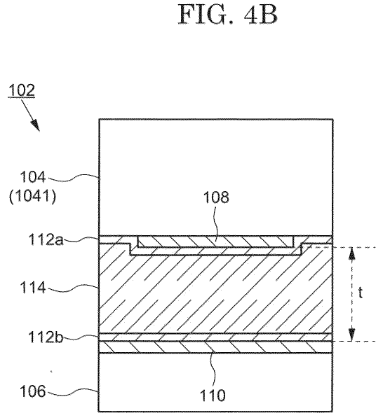

FIG. 4A and FIG. 4B show the reflecting surface unit cell 102 used in a radio wave reflecting device according to an embodiment of the present invention. FIG. 4A shows a plan view when the reflecting surface unit cell 102 is viewed from above (the side where radio waves are incident), and FIG. 4B shows a cross-sectional view between A1-A2 shown in the plan view.

As shown in FIG. 4A and FIG. 4B, the reflecting surface unit cell 102 includes the dielectric substrate 104, the counter substrate 106, the patch electrode 108, the ground electrode 110, the liquid crystal layer 114, a first alignment film 112a, and a second alignment film 112b. In the reflecting surface unit cell 102, the dielectric substrate 104 may be regarded as a single layer (dielectric layer). The patch electrode 108 is provided on the dielectric substrate (dielectric layer) 104, and the ground electrode 110 is provided on the counter substrate 106. The first alignment film 112a is provided on the dielectric substrate (dielectric layer) 104 to cover the patch electrode 108. The second alignment film 112b is provided on the counter substrate 106 to cover the ground electrode 110. The patch electrode 108 and the ground electrode 110 are arranged to face each other, and the liquid crystal layer 114 is provided between the patch electrode 108 and the ground electrode 110. The first alignment film 112a is interposed between the patch electrode 108 and the liquid crystal layer 114. The second alignment film 112b is interposed between the ground electrode 110 and the liquid crystal layer 114.

The patch electrode 108 preferably has a shape symmetrical with respect to the vertically polarized and horizontally polarized waves of the incident radio wave. For example, the patch electrode 108 has a square or circular shape in a plan view. FIG. 4A shows the case where the patch electrode 108 has a square shape in a plan view. There is no particular limitation on the shape of the ground electrode 110, and the ground electrode 110 has a shape that spreads over substantially the entire surface of the counter substrate 106 to have a larger area than the patch electrode 108. There is no limitation on the material forming the patch electrode 108 and the ground electrode 110. The patch electrode 108 and the ground electrode 110 are formed using a conductive metal or metal oxide. The dielectric substrate (dielectric layer) 104 may be provided with a first wiring 118. The first wiring 118 is connected to the patch electrode 108. The first wiring 118 is used when the control signal is supplied to the patch electrode 108. When the plurality of reflecting surface unit cells is aligned, the first wiring 118 is used to connect a patch electrode to an adjacent patch electrode.

Although not shown in FIG. 4A and FIG. 4B, the dielectric substrate (dielectric layer) 104 and the counter substrate 106 are bonded together by the sealing material 128. The dielectric substrate (dielectric layer) 104 and the counter substrate 106 are arranged to face each other with a gap. The liquid crystal layer 114 is provided within the region surrounded by the sealing material 128. The liquid crystal layer 114 is provided to fill the gap between the dielectric substrate (dielectric layer) 104 and the counter substrate 106. A distance between the dielectric substrate (dielectric layer) 104 and the counter substrate 106 is greater than 0.5 mm or 0.6 mm or greater. The patch electrode 108, the ground electrode 110, the first alignment film 112a, and the second alignment film 112b are provided between the dielectric substrate (dielectric layer) 104 and the counter substrate 106. Therefore, a distance between the first alignment film 112a and the second alignment film 112b provided on each of the dielectric substrate 104 and the counter substrate 106 is precisely the thickness of the liquid crystal layer 114. Although not shown in FIG. 4B, a spacer for keeping the distance constant may be provided between the dielectric substrate (dielectric layer) 104 and the counter substrate 106.

A control signal for controlling the alignment of the liquid crystal molecule 116 of the liquid crystal layer 114 is supplied to the patch electrode 108. The control signal is a DC voltage signal or a polarity inversion signal in which a positive DC voltage and a negative DC voltage are alternately inverted. In the case of the polarity inversion signal in which a positive DC voltage and a negative DC voltage are alternately inverted, a voltage at a ground level or an intermediate level of the polarity inversion signal is supplied to the ground electrode 110. When the control signal is supplied to the patch electrode 108, the alignment status of the liquid crystal molecules contained in the liquid crystal layer 114 changes. A liquid crystal material having dielectric anisotropy is used for the liquid crystal layer 114. For example, a nematic liquid crystal, a smectic liquid crystal, a cholesteric liquid crystal, or a discotic liquid crystal can be used as the liquid crystal layer 114. The dielectric constant of the liquid crystal layer 114 with dielectric anisotropy changes due to a change in the alignment status of the l liquid crystal molecules. The reflecting surface unit cell 102 can change the dielectric constant of the liquid crystal layer 114 by the control signal supplied to the patch electrode 108, and the phase of the reflected wave can be delayed when reflecting radio waves.

The frequency bands of the radio waves reflected by the reflecting surface unit cell 102 are a microwave (SHF: Super High Frequency) band. The alignment of the liquid crystal molecule 116 of the liquid crystal layer 114 changes in response to the control signal supplied to the patch electrode 108, however, the alignment of the liquid crystal molecule 116 hardly follows the frequency of the radio wave irradiated onto the patch electrode 108. Therefore, the reflecting surface unit cell 102 can control the phase of the reflected radio wave without being affected by the radio wave.

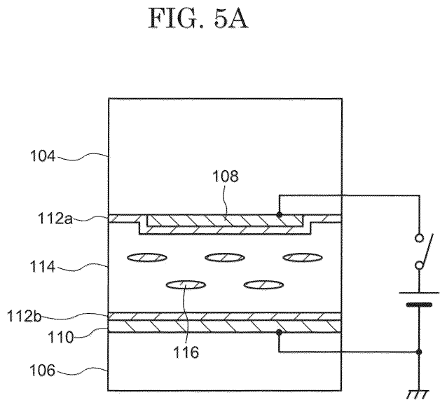

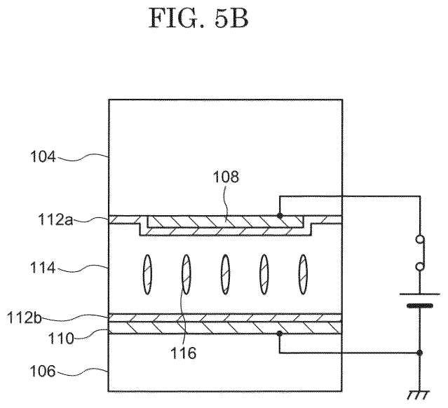

FIG. 5A shows a state (referred to as a “first state”) in which no voltage is supplied between the patch electrode 108 and the ground electrode 110. FIG. 5A shows the case where the first alignment film 112a and the second alignment film 112b are horizontal alignment films. In the first state, the long axes of the liquid crystal molecules 116 are horizontally aligned with respect to the surfaces of the patch electrode 108 and the ground electrode 110 by the first alignment film 112a and the second alignment film 112b. FIG. 5B shows a state (referred to as a “second state”) in which a control signal (voltage signal) is supplied to the patch electrode 108. In the second state, the long axes of the liquid crystal molecules 116 are vertically aligned with respect to the surfaces of the patch electrode 108 and the ground electrode 110 due to the influence of an electric field. An angle at which the long axis of the liquid crystal molecule 116 is aligned can also be aligned in an intermediate direction between the horizontal direction and the vertical direction, depending on the magnitude of the control signal supplied to the patch electrode 108 (the voltage magnitude between the counter electrode and the patch electrode).

When the liquid crystal molecule 116 has a positive dielectric anisotropy, the dielectric constant is greater in the second state than in the first state. On the other hand, when the liquid crystal molecule 116 has a negative dielectric anisotropy, the apparent dielectric constant is smaller in the second state than in the first state. The liquid crystal layer 114 with dielectric anisotropy can be regarded as a variable dielectric layer. The reflecting surface unit cell 102 can be controlled to delay (or not delay) the phase of the reflected wave by utilizing the dielectric anisotropy of the liquid crystal layer 114.

The reflecting surface unit cell 102 is used as a reflector that reflects radio waves in a predetermined direction. It is preferable that the amplitude of the radio wave reflected by the reflecting surface unit cell 102 is attenuated as little as possible. As is clear from the structure shown in FIG. 4B, when radio waves propagating through the air are reflected by the reflecting surface unit cell 102, the radio waves pass through the dielectric substrate (dielectric layer) 104 twice. For example, the dielectric substrate (dielectric layer) 104 is formed from dielectric materials such as glass or resin. When radio waves pass through the dielectric, the phase velocity of the radio waves changes, so to prevent the amplitude of the reflected wave from attenuating, it is preferable to make the thickness of the dielectric substrate (dielectric layer) 104 to be equivalent to ¼ wavelength of the wavelength of the reflected radio waves.

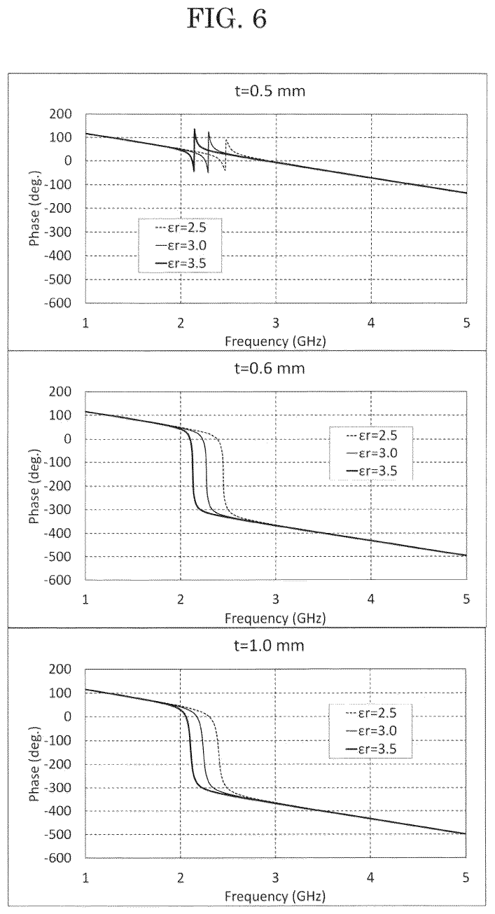

FIG. 6 shows the simulation results of a relationship between a thickness of the liquid crystal layer and a phase change of the reflected wave in the radio wave reflecting device according to an embodiment of the present invention. The simulation shown in FIG. 6 is calculated with the plurality of reflecting surface unit cells 102 arranged, assuming a plate-shaped radio wave reflecting device. In the simulation, the conditions are set such that the microwave frequency is 2.4 GHz, the size of the patch electrode 108 in the reflecting surface unit cell 102 is 36 mm×36 mm, and the patch electrode 108 of this size is aligned at a pitch of 50 mm. In the simulation, calculations were performed using a thickness t of the liquid crystal layer 114 of the reflecting surface unit cell 102 as a parameter. This simulation was performed using CST Studio Suite (manufactured by Dassault Systems K.K.).

In FIG. 6, three graphs are shown in the vertical direction. In each graph, the vertical axis represents phase and the horizontal axis represents frequency. The top graph shows the simulation results calculated under the condition that the thickness t of the liquid crystal layer 114=0.5 mm. The middle graph shows the simulation results calculated under the condition that the thickness t of the liquid crystal layer 114=0.6 mm. The bottom graph is the simulation results calculated under the condition that the thickness t of the liquid crystal layer 114=1.0 mm. Although not shown, the simulation results calculated under the conditions of the liquid crystal layer thicknesses t=0.7 mm, 0.8 mm, and 0.9 mm are almost the same as the simulation results calculated under the conditions of the liquid crystal layer thickness t=0.6 mm and 1.0 mm.

Each of the top, middle, and bottom graphs shows three simulation results. The three simulation results are obtained for the liquid crystal layer 114 with different relative permittivities (ε=2.5, 3.0, 3.5). The difference in the relative permittivity ε indicates different alignments of the liquid crystal molecules 116 in the radio wave reflecting device 100. That is, at a frequency of 2.4 GHz, the relatively large phase difference between conditions with different relative permittivities ε means that the reflection angle when reflecting microwaves can be changed relatively greatly.

In other words, the condition with the thickness t of the liquid crystal layer 0.6 mm allows for a greater change in the reflection angle of microwaves than the condition with the thickness t=0.5 mm. Therefore, when the thickness t of the liquid crystal layer 114 is greater than 0.5 mm, the reflection angle of microwaves can be significantly increased by the radio wave reflecting device 100. Alternatively, when the thickness t of the liquid crystal layer 114 is 0.6 mm or greater, the reflection angle of microwaves can be rapidly increased by the radio wave reflecting device 100.

As described above, according to the radio wave heating device 10 according to the present embodiment, the reflection angle of the radio wave emitted from the radio wave emission source 300 can be changed by the radio wave reflecting device 100. Therefore, by adjusting the reflection angle of the radio wave according to the position and size of the object to be heated 310, the radio wave can be efficiently and uniformly irradiated onto the object to be heated 310. As a result, the object to be heated 310 can be heated efficiently and uniformly.

Although the configuration for controlling the reflection angle of the radio wave reflecting device 100 based on the position information of the object to be heated 310 detected by the sensor 400 has been exemplified in the present embodiment, the present invention is not limited to this configuration. For example, the control circuit 500 may control the drive circuit 600 so that the radio wave reflected by the radio wave reflecting device 100 is irradiated over the entire region of the heating chamber 200.

### 1-5. Radio Wave Reflecting Device 100

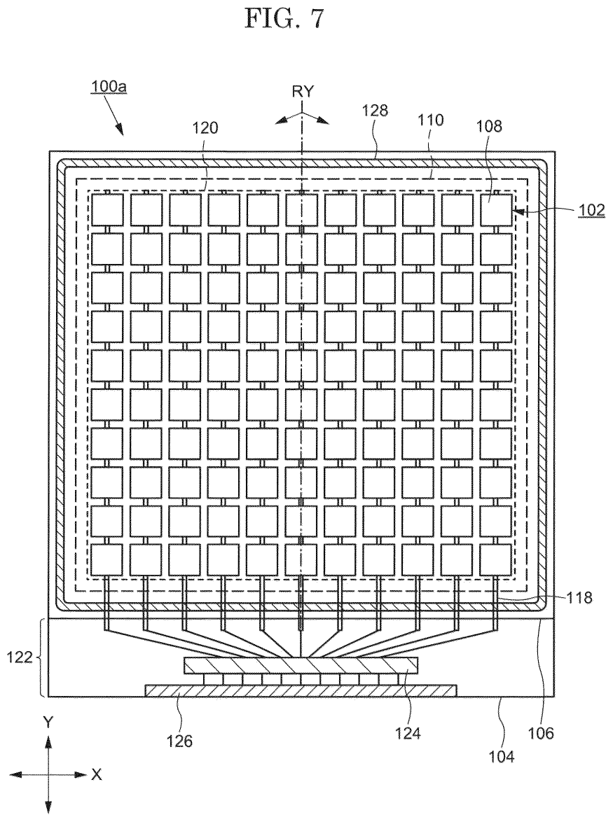

The radio wave reflecting device 100 in which the reflecting surface unit cell 102 is integrated will be described with reference to FIG. 7 to FIG. 10. The radio wave reflecting device 100 has a single-axis reflection control method and a dual-axis reflection control method. Each control method will be described below.

### 1-5-1. Radio Wave Reflecting Device A (single-Axis Reflection Control)

FIG. 7 shows a configuration of a radio wave reflecting device 100a according to an embodiment of the present invention. The radio wave reflecting device 100a has a reflecting surface 120. The reflecting surface 120 is composed of the plurality of reflecting surface unit cells 102. For example, the plurality of reflecting surface unit cells 102 is arranged in a first direction (X-axis direction shown in FIG. 7) and a second direction (Y-axis direction shown in FIG. 7) intersecting the first direction. The reflecting surface unit cell 102 is arranged so that the patch electrode 108 faces the radio wave incident surface. The reflecting surface 120 is flat plate-shaped, and a plurality of patch electrodes 108 is arranged in a matrix inside the flat plate-shaped surface. The radio wave reflecting device 100a (single-axis reflection control) shown in FIG. 7 may not include the switching element 134.

The radio wave reflecting device 100 has a structure in which the plurality reflecting surface unit cells 102 is integrated on one dielectric substrate (dielectric layer) 104. As shown in FIG. 7, the radio wave reflecting device 100 has a structure including the dielectric substrate (dielectric layer) 104 on which the plurality of patch electrodes 108 is arranged and the counter substrate 106 on which the ground electrode 110 is provided are stacked one on another, with the liquid crystal layer 114 provided between the dielectric substrate (dielectric layer) 104 and the counter substrate 106. The reflecting surface 120 is formed in a region where the plurality of patch electrodes 108 and the ground electrode 110 overlap. For each patch electrode 108, a cross-sectional structure of the reflecting surface 120 is the same as the structure of the reflecting surface unit cell 102 shown in FIG. 4B. The dielectric substrate (dielectric layer) 104 and the counter substrate 106 are bonded together with the sealing material 128, and the liquid crystal layer 114 is provided in a region inside the sealing material 128.

The dielectric substrate (dielectric layer) 104 has a thickness equivalent to ¼ wavelength of the wavelength of the reflected radio waves. The dielectric substrate (dielectric layer) 104 also has a peripheral region 122 extending outward from the counter substrate 106 in addition to a region facing the counter substrate 106. A first drive circuit 124 and the terminal portion 126 are provided in the peripheral region 122. The first drive circuit 124 outputs a control signal to the patch electrodes 108. In this configuration, the first drive circuit 124 corresponds to the drive circuit 600. The terminal portion 126 is a region for forming a connection with an external circuit, and the FPC 160 is connected to the terminal portion 126. A signal for controlling the first drive circuit 124 is input to the terminal portion 126.

As described above, the plurality of patch electrodes 108 is arranged in the first direction (X-axis direction) and the second direction (Y-axis direction) in the dielectric substrate (dielectric layer) 104. A plurality of first wirings 118 extending in the second direction (Y-axis direction) is arranged in the dielectric substrate (dielectric layer) 104. Each of the plurality of first wirings 118 is electrically connected to the plurality of patch electrodes 108 arranged in the second direction (Y-axis direction). In other words, the plurality of patch electrodes 108 arranged in the second direction (Y-axis direction) is connected by the first wiring 118. The reflecting surface 120 has a configuration in which a plurality of patch electrode arrays connected by the first wiring 118 is arranged in a row in the first direction (X-axis direction).

The plurality of first wirings 118 arranged on the reflecting surface 120 extends to the peripheral region 122 and is connected to the first drive circuit 124. The first drive circuit 124 outputs the control signal supplied to the patch electrodes 108. The first drive circuit 124 can output control signals at different voltage levels to each of the plurality of first wirings 118. As a result, in the reflecting surface 120, the control signal is supplied to each column (for each patch electrode 108 arranged in the second direction (Y-axis direction)) of the plurality of patch electrodes 108 arranged in the first direction (X-axis direction) and the second direction (Y-axis direction).

In the radio wave reflecting device 100a, the control signal is supplied for each set of the plurality of patch electrodes 108 arranged in the second direction (Y-axis direction). As a result, the reflection direction of the radio wave incident on the reflecting surface 120 is controlled. That is, the radio wave reflecting device 100a can control the propagation direction of the reflected wave of the radio wave irradiated onto the reflecting surface 120 in the left-right direction of the drawing, centered on a reflection axis RY parallel to the second direction (Y-axis direction).

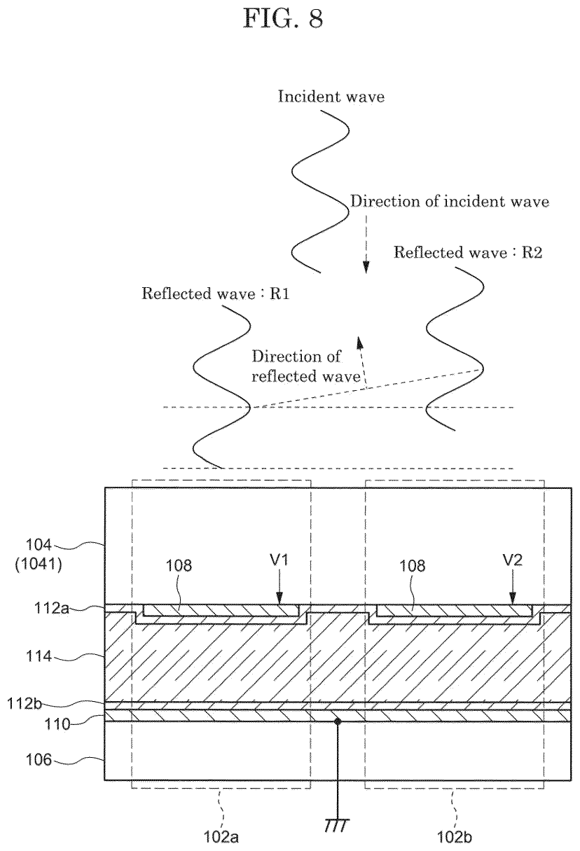

FIG. 8 schematically shows a change in the propagation direction of the reflected wave by the two reflecting surface unit cells 102. When the radio wave is incident on a first reflecting surface unit cell 102a and a second reflecting surface unit cell 102b in the same phase, and different control signals (V1≠V2) are supplied to the first reflecting surface unit cell 102a and the second reflecting surface unit cell 102b, the phase change of the reflected wave due to the second reflecting surface unit cell 102b is larger than that of the first reflecting surface unit cell 102a. As a result, the phase of the reflected wave R1 reflected by the first reflecting surface unit cell 102a is different from the phase of the reflected wave R2 reflected by the second reflecting surface unit cell 102b (in FIG. 8, the phase of the reflected wave R2 is advanced from the phase of the reflected wave R1), and apparently, the propagation direction of the reflected wave changes in an oblique direction.

In FIG. 7, since the plurality of patch electrodes 108 arranged in the second direction (Y-axis direction) is electrically connected by the first wiring 118 and is electrically equipotential, it is conceivable to replace the plurality of patch electrodes 109 with a belt-shaped electrode that is continuous in the second direction (Y-axis direction) rather than a shape divided into multiple parts. However, since there is an appropriate range for the dimensions of the patch electrodes 108 depending on the wavelength of the reflected radio wave, if the patch electrode 108 is a belt-shaped electrode, the sensitivity to the target wavelength will decrease, and the behavior for the vertically polarized and horizontally polarized waves will be different. Therefore, as shown in FIG. 7, it is preferable that each patch electrode 108 has a shape symmetrical with respect to the vertically polarized and horizontally polarized waves (in FIG. 7, the patch electrode 108 is square-shaped, but the shape of the patch electrode 108 may also be circular), and the plurality of patch electrodes 108 is arranged in an array, and the plurality of patch electrodes 108 arranged parallel to the reflection axis RY is connected by the first wiring 118.

Although not shown, the thickness of the dielectric substrate (dielectric layer) 104 of the radio wave reflecting device 100 a shown in FIG. 7 is equivalent to ¼ wavelength of the target radio wave. This suppresses the attenuation of the amplitude of the reflected wave reflected by the radio wave reflecting device 100.

### 1-5-2. Radio Wave Reflecting Device B (Dual-Axis Reflection Control)

Since the radio wave reflecting device 100a described above has a single-axis reflection axis RY, the reflection angle can be controlled in a direction with the reflection axis RY as the rotation axis. A radio wave reflecting device 100b described below is capable of dual-axis reflection control. In the following description, differences from the radio wave reflecting device 100a described above will be mainly described.

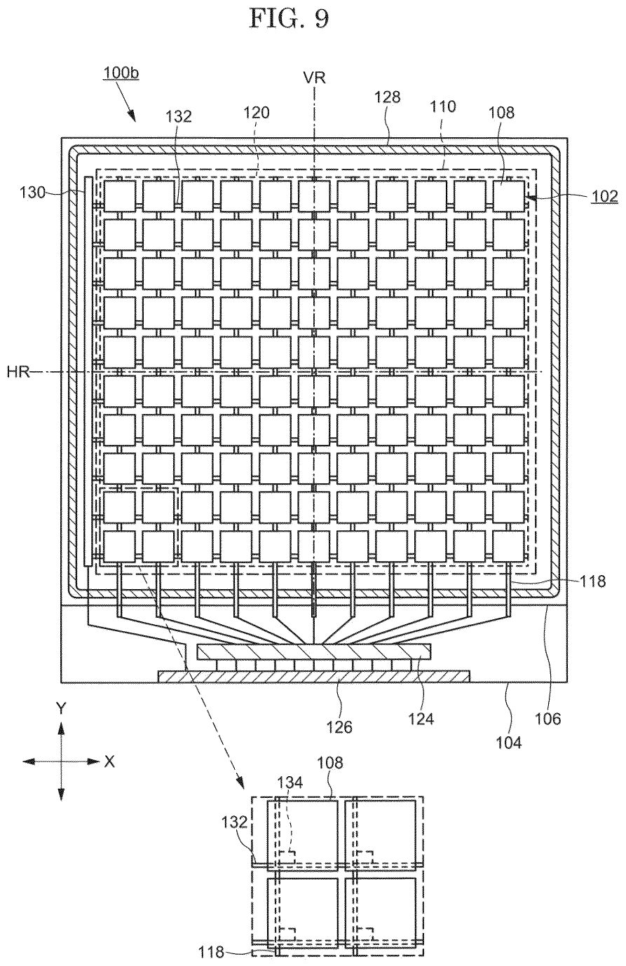

FIG. 9 shows a configuration of the radio wave reflecting device 100b according to the present embodiment. Differences from the radio wave reflecting device 100a shown in FIG. 7 will be mainly described below.

The radio wave reflecting device 100b includes the plurality of first wirings 118 extending in the second direction (Y-axis direction) and a plurality of second wirings 132 extending in the first direction (X-axis direction) on the reflecting surface 120. The plurality of first wirings 118 and the plurality of second wirings 132 are arranged to intersect with an insulating layer sandwiched between them. The plurality of first wirings 118 is connected to the first drive circuit 124, and the plurality of second wirings 132 is connected to a second drive circuit 130. The first drive circuit 124 outputs a control signal, and the second drive circuit 130 outputs a scan signal. In this configuration, the first drive circuit 124 and the second drive circuit 130 correspond to the drive circuit 600. In FIG. 9, the first drive circuit 124 is shown as an embodiment in which an IC chip or the like is mounted on the dielectric substrate 104. Similar to the switching element 134, although the second drive circuit 130 is shown as a drive circuit using a thin-film transistor formed on the dielectric substrate 104, the present invention is not limited to this.

FIG. 9 shows an enlarged inset view of the arrangement of four patch electrodes 108 and two wiring (the first wiring 118 and the second wiring 132). Each of the four patch electrodes 108 is provided with the switching element 134. The switching (on and off) of the switching element 134 is controlled by the scan signal supplied to the second wiring 132. The patch electrode 108, whose switching element 134 is turned on, conducts with the first wiring 118, and the control signal is supplied to that patch electrode 108. For example, the switching element 134 is formed by a thin-film transistor. With this configuration, the plurality of patch electrodes 108 arranged in the first direction (X-axis direction) can be selected by row, and control signals at different voltage levels can be supplied to each row.

The radio wave reflecting device 100b shown in FIG. 9 can control the propagation direction of the reflected wave of the radio wave irradiated onto the reflecting surface 120 in the left-right direction of the drawing, centered on a reflection axis VR parallel to the second direction (Y-axis direction), and also in the up-down direction in the drawing, centered on a reflection axis HR parallel to the first direction (X-axis direction). That is, since the radio wave reflecting device 100 includes the reflection axis VR parallel to the second direction (Y-axis direction) and the reflection axis VH parallel to the first direction (X-axis direction), the reflection angle can be controlled in the direction with the reflection axis VR as the rotation axis and in the direction with the reflection axis HR as the rotation axis.

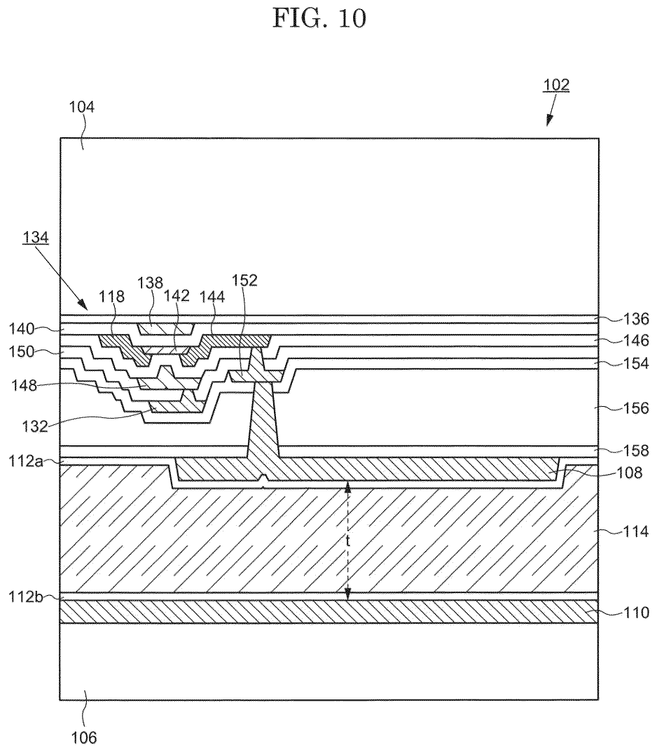

FIG. 10 shows an example of a cross-sectional structure of the reflecting surface unit cell 102 in which the switching element 134 is connected to the patch electrode 108. The switching element 134 is provided on the dielectric substrate (dielectric layer) 104. The switching element 134 is a transistor, and has a structure in which a first gate electrode 138, a first gate insulating layer 140, a semiconductor layer 142, a second gate insulating layer 146, and a second gate electrode 148 are stacked. An undercoat layer 136 may be provided between the first gate electrode 138 and the dielectric substrate (dielectric layer) 104. The first wiring 118 is provided between the first gate insulating layer 140 and the second gate insulating layer 146. The first wiring 118 is provided to be in contact with the semiconductor layer 142. A first connecting wiring 144 is provided in the same layer as the conductive layer forming the first wiring 118. The first connecting wiring 144 is provided to be in contact with the semiconductor layer 142. The connection structure of the first wiring 118 and the first connecting wiring 144 to the semiconductor layer 142 shows that one wiring is connected to a source of the transistor and the other wiring is connected to a drain of the transistor.

A first interlayer insulating layer 150 is provided to cover the switching element 134. The second wiring 132 is provided under the first interlayer insulating layer 150. The second wiring 132 is connected to the second gate electrode 148 via a contact hole formed in the first interlayer insulating layer 150. Although not shown, the first gate electrode 138 and the second gate electrode 148 are electrically connected in a region that does not overlap the semiconductor layer 142. A second connecting wiring 152 is provided under the first interlayer insulating layer 150 in the same conductive layer as the second wiring 132. The second connecting wiring 152 is connected to the first connecting wiring 144 via a contact hole formed in the first interlayer insulating layer 150.

A second interlayer insulating layer 154 is provided to cover the second wiring 132 and the second connecting wiring 152. A planarization layer 156 is provided to fill the steps of the switching element 134. The planarization layer 156 is provided, and then the patch electrode 108 can be formed without being affected by the arrangement of the switching element 134. The passivation layer 158 is provided under the flat surface of the planarization layer 156. The patch electrode 108 is provided under the passivation layer 158. The patch electrode 108 is connected to the second connecting wiring 152 via a contact hole that penetrates the passivation layer 158, the planarization layer 156, and the second interlayer insulating layer 154. The first alignment layer 112a is provided under the patch electrode 108.

Similar to FIG. 4B, the counter substrate 106 includes the ground electrode 110 and the second alignment layer 112b. The dielectric substrate (dielectric layer) 104 and the counter substrate are arranged so that the surface of the dielectric substrate (dielectric layer) 104 provided with the switching element 134 and the patch electrode 108 faces the surface of the counter substrate provided with the ground electrode 110. The liquid crystal layer 114 is provided between the dielectric substrate (dielectric layer) 104 and the counter substrate. The thickness t of the liquid crystal layer 114 can be defined as a length from the surface of the liquid crystal layer 114 side of the patch electrode 108 to the surface of the liquid crystal layer 114 side of the ground electrode 110. In this case, the thickness t of the liquid crystal layer 114 may include a thickness of at least one insulating layer (the undercoat layer 136, the first gate insulating layer 140, the second gate insulating layer 146, the first interlayer insulating layer 150, the second interlayer insulating layer 154, the planarization layer 156, the passivation layer 158) between the patch electrode 108 and the dielectric substrate (dielectric layer) 104.

Each layer formed on the dielectric substrate (dielectric layer) 104 is formed using materials described below. For example, the undercoat layer 136 is formed of a silicon oxide film. For example, the first gate insulating layer 140 and the second gate insulating layer 146 are formed of a silicon oxide film or a stacked structure of a silicon oxide film and a silicon nitride film. The semiconductor layer is formed of a silicon semiconductor, such as amorphous silicon and polycrystalline silicon, and an oxide semiconductor containing a metal oxide, such as indium oxide, zinc oxide, and gallium oxide. For example, the first gate electrode 138 and the second gate electrode 148 may be composed of molybdenum (Mo), tungsten (W), or an alloy thereof. The first wiring 118, the second wiring 132, the first connecting wiring 144, and the second connecting wiring 152 are formed using a metal material such as titanium (Ti), aluminum (Al), or molybdenum (Mo). For example, the gate electrodes and wirings may be composed of a stacked structure of titanium (Ti)/aluminum (Al)/titanium (Ti), or a stacked structure of molybdenum (Mo)/aluminum (Al)/molybdenum (Mo). The planarization layer 156 is formed of a resin material such as acrylic or polyimide. For example, the passivation layer 158 is formed of a silicon nitride film. The patch electrode 108 and the ground electrode 110 are formed of a metal film such as aluminum (Al), copper (Cu), or a transparent conductive film such as indium tin oxide (ITO).

As shown in FIG. 10, the second wiring 132 is connected to a gate of the transistor used as the switching element 134, the first wiring 118 is connected to one of the source and the drain of the transistor, and the patch electrode 108 is connected to the other of the source and the drain, whereby a predetermined patch electrode can be selected from the plurality of patch electrodes 108 arranged in a matrix and the control signal can be supplied. Furthermore, by providing the switching element 134 in the individual patch electrodes 108 in the reflecting surface 120, a control voltage can be supplied to each of the patch electrodes 108 arranged in a row along the first direction (X-axis direction) or each of the patch electrodes 108 arranged in a row along the second direction (Y-axis direction). For example, with this configuration, when the reflecting surface 120 is upright, a reflection direction of the reflected wave can be controlled in the left-right direction and the up-down direction.

### 1-6. Influence of Microwaves on Liquid Crystal Layer 114

When the radio waves used in the radio wave heating device 10 are microwaves (frequency=2.4 GHz), the influence of the microwaves on the liquid crystal layer 114 will be described.

A microwave power P absorbed by the dielectric is expressed by the following equation.

$$P = K \cdot {ε}_{r} \cdot tan δ \cdot f \cdot {E}^{2} [ W / {cm}^{3} ]$$

The parameters are as follows.
K: 0.556×10⁻¹⁰
εᵣ: Dielectric constant of the dielectric
tan δ: Dielectric loss angle of the dielectric
f: Frequency [Hz]
E: Electric field strength [V/m]

When considering the microwave power P described above for water, glass, and liquid crystal, the values of εᵣ and tan δ of the liquid crystal are much smaller than the values for water, and are smaller than the values for glass. Therefore, even if the liquid crystal layer 114 is used in the radio wave reflecting device 100 in the radio wave heating device 10 using the microwaves described above, the liquid crystal layer 114 is hardly heated by the microwaves.

### 2. Second Embodiment

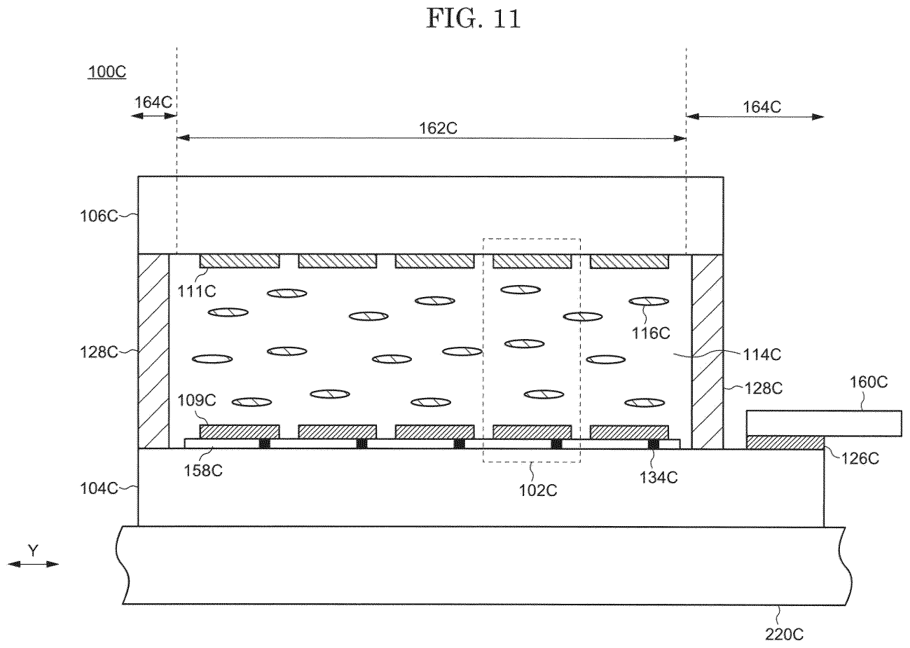

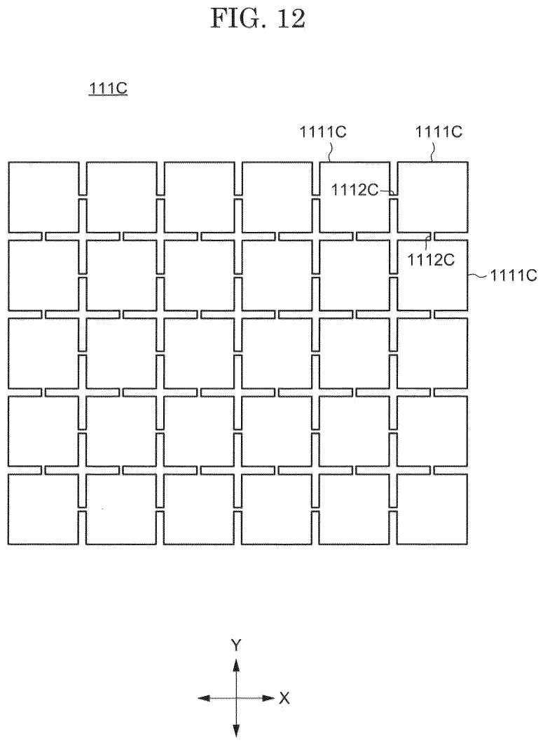

A radio wave heating device 10C according to an embodiment of the present invention will be described with reference to FIG. 11 and FIG. 12. A configuration of the radio wave heating device 10C according to the second embodiment is similar to the configuration of the radio wave heating device 10 according to the first embodiment. In the following description, descriptions of a configuration similar to that of the radio wave heating device 10 will be omitted, and the configuration different from the radio wave heating device 10 will be described. In the following description, when a configuration similar to that of the first embodiment is described, FIG. 1 to FIG. 10 will be used, and the description will be given with the letter “C” added to the signs shown in FIG. 1 to FIG. 10.

### 2-1. Radio Wave Reflecting Device 100c

FIG. 11 is a cross-sectional view showing an overview of a radio wave reflecting device of a radio wave heating device according to an embodiment of the present invention. As shown in FIG. 11, a radio wave reflecting device 100C includes a plurality of reflecting elements (reflecting surface unit cells) 102C. The plurality of reflecting surface unit cells 102C is arranged in at least one direction. In FIG. 11, the plurality of reflecting surface unit cells 102C is arranged in the Y-axis direction. The radio wave reflecting device 100C includes a dielectric substrate 104C, a counter substrate 106C, a drive electrode 109C, a patch electrode (counter electrode) 111C, a liquid crystal layer 114C, a sealing material 128C, a switching element 134C, a terminal portion 126C, and an FPC 160C. The liquid crystal layer 114C contains a liquid crystal molecule 116C. In this configuration, the electrode 111C provided on the counter substrate 106C side functions as a patch electrode that reflects radio waves. The liquid crystal is aligned according to a potential difference between the potential applied to the drive electrode 109C and a potential applied to the patch electrode 111C, and the dielectric constant changes. A passivation layer 158C is provided between the drive electrode 109C and the dielectric substrate 104C.

The reflecting surface unit cell 102C includes at least the drive electrode 109C, the patch electrode 111C, the liquid crystal layer 114C, and the switching element 134C. Although it appears that the patch electrode 111C is individually provided for each reflecting surface unit cell 102C in FIG. 11, but actually, as shown in FIG. 12, the patch electrode 111C is commonly provided to the plurality of reflecting surface unit cells 102C. The drive electrode 109C is provided on the dielectric substrate 104C side. The drive electrode 109C faces the patch electrode 111C and is individually provided for each reflecting surface unit cell 102C. The patch electrode 111C is provided on the counter substrate 106C side.

The dielectric substrate 104C is arranged closer to a side wall 220C than the counter substrate 106C. In other words, the counter substrate 106C is provided on an inner side of a heating chamber 200C or closer to a radio wave emission source 300C than the dielectric substrate 104C. Similarly, the patch electrode (counter electrode) 111C is provided closer to the radio wave emission source 300C than the drive electrode 109C. Although a configuration in which the dielectric substrate 104C is provided to be in contact with the side wall 220C is exemplified in FIG. 11, the present invention is not limited to this configuration. For example, another component may be provided between the dielectric substrate 104C and the side wall 220C.

The switching element 134C is connected to the drive electrode 109C. The switching element 134C is provided farther from the radio wave emission source 300C than the drive electrode 109C. In FIG. 11, the drive electrode 109C is arranged to overlap the switching element 134C. This configuration suppresses the switching element 134C from being affected by radio waves. The switching element 134C is driven by a drive circuit 600C (see FIG. 1). The alignment of the liquid crystal molecule 116C is controlled according to the driving state of the switching element 134C. As described above, the alignment of the liquid crystal molecule 116C is controlled so that the phase of the radio wave reflected by the radio wave reflecting device 100C is controlled. By controlling the phase of this radio wave, the propagation direction of the reflected radio wave is controlled.

As described above, in the case of the radio wave heating device 10C according to the present embodiment, since the radio waves emitted from the radio wave emission source 300C are shielded or absorbed by the patch electrode 111C, adverse effects such as heating in the switching element 134C due to exposure to these radio waves can be minimized. Therefore, the radio wave shielding component 320 shown in FIG. 3 can be omitted.

### 2-2. Drive Electrode 109c

FIG. 12 is a plan view showing an overview of the patch electrode of the radio wave heating device according to an embodiment of the present invention. As shown in FIG. 12, the patch electrode 111C includes a resonant portion 1111C and a connecting portion 1112C.

The resonant portion 1111C is a portion that resonates with the wavelength of the radio wave emitted from the radio wave emission source 300C, and is arranged in a matrix in the X-axis and Y-axis directions. The size of the resonant portion 1111C in the X-axis and Y-axis directions is calculated using the wavelength of the radio wave and the dielectric constant of the liquid crystal layer 114C. In the present embodiment, the frequency of microwaves emitted from the radio wave emission source 300C is 2.4 GHz, the wavelength is 125 mm, and the size of the resonant portion 1111C in the X-axis and Y-axis directions is 36 mm.

The connecting portion 1112C connects the resonant portions 1111C adjacent in the X-axis direction or the Y-axis direction. The resonant portions 1111C arranged in a matrix are electrically connected by the connecting portion 1112C. Therefore, the resonant portions 1111C arranged in a matrix are at the same potential. The connecting portion 1112C has an elongated shape in the X-axis direction or the Y-axis direction. The connecting portion 1112C connecting the resonant portions 1111C adjacent in the X-axis direction is elongated in the X-axis direction. The connecting portion 1112C connecting the resonant portions 1111C adjacent in the Y-axis direction is elongated in the Y-axis direction.

A width of the connecting portion 1112C elongated in the X-axis direction (width in the Y-axis direction) is 1/100 or less of the size of the resonant portion 1111C in the Y-axis direction. A width of the connecting portion 1112C elongated in the Y-axis direction (width in the X-axis direction) is 1/100 or less of the size of the resonant portion 1111C in the X-axis direction. With this configuration, the connecting portion 1112C can reduce the influence of resonance of the resonant portion 1111C.

As described above, according to the radio wave heating device 10C of the present embodiment, the radio wave reflecting device 100C can change the reflection angle of the radio wave emitted from the radio wave emission source 300C. Therefore, by adjusting the reflection angle of the radio wave according to the position and size of the object to be heated 310C, the radio waves can be efficiently and uniformly irradiated onto the object to be heated 310C. As a result, the object to be heated 310C can be heated efficiently and uniformly.

Various configurations of the radio wave heating device and the reflecting surface unit exemplified as an embodiment of the present invention can be appropriately combined as long as no contradiction is caused. Further, the addition, deletion, or design change of components, or the addition, deletion, or condition change of processes as appropriate by those skilled in the art based on the radio wave heating device and the reflecting surface unit are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. A radio wave irradiation device comprising:
a radio wave emission source configured to emit radio waves; and
a radio wave reflecting device provided on a side wall of a space in which an object to be heated is accommodated, the radio wave reflecting device being configured to reflect the radio waves emitted from the radio wave emission source,
wherein
the radio wave reflecting device includes a plurality of reflecting elements arranged in at least one direction, and
the reflecting elements include:
a patch electrode;
a counter electrode facing the patch electrode; and
a liquid crystal layer disposed between the patch electrode and the counter electrode.

2. The radio wave irradiation device according to claim 1, wherein a thickness of the liquid crystal layer is greater than 0.5 mm.

3. The radio wave irradiation device according to claim 1, wherein a thickness of the liquid crystal layer is 0.6 mm or greater.

4. The radio wave irradiation device according to claim 1, wherein the radio waves are microwaves.

5. The radio wave irradiation device according to claim 1, wherein the reflecting elements further include a switching element connected to the patch electrode.

6. The radio wave irradiation device according to claim 5, further comprising a radio wave shielding member configured to shield the radio waves or a radio wave absorbing member configured to absorb the radio waves,
wherein
the patch electrode is arranged closer to the radio wave emission source than the counter electrode,
the switching element is arranged closer to the radio wave emission source than the patch electrode, and
the radio wave shielding member or the radio wave absorbing member is arranged closer to the radio wave emission source than the switching element.

7. The radio wave irradiation device according to claim 1, wherein the reflecting elements further include a switching element connected to the counter electrode.

8. The radio wave irradiation device according to claim 7, wherein
the patch electrode is arranged closer to the radio wave emission source than the counter electrode, and
the switching element is arranged farther from the radio wave emission source than the counter electrode.

9. The radio wave irradiation device according to claim 5, further comprising:
a drive circuit configured to drive the switching element; and
a radio wave shielding member configured to shield the radio waves or a radio wave absorbing member configured to absorb the radio waves,
wherein
the radio wave reflecting device is divided into a radio wave reflecting region in which the patch electrodes are arranged and a peripheral region surrounding the radio wave reflecting region,
the drive circuit is arranged in the peripheral region, and
the radio wave shielding member or the radio wave absorbing member is arranged closer to the radio wave emission source than the drive circuit.

10. The radio wave irradiation device according to claim 7, further comprising:
a drive circuit configured to drive the switching element; and
a radio wave shielding member configured to shield the radio waves or a radio wave absorbing member configured to absorb the radio waves,
wherein
the radio wave reflecting device is divided into a radio wave reflecting region in which the patch electrodes are arranged and a peripheral region surrounding the radio wave reflecting region,
the drive circuit is arranged in the peripheral region, and
the radio wave shielding member or the radio wave absorbing member is arranged closer to the radio wave emission source than the drive circuit.

11. The radio wave irradiation device according to claim 5, further comprising:
a sensor configured to detect a position of an object to be heated;
a drive circuit configured to drive the switching element; and
a control circuit configured to control the drive circuit,
wherein the control circuit is configured to control the drive circuit based on position information of the object to be heated detected by the sensor.

12. The radio wave irradiation device according to claim 7, further comprising:
a sensor configured to detect a position of the object to be heated;
a drive circuit configured to drive the switching element; and
a control circuit configured to control the drive circuit,
wherein the control circuit is configured to control the drive circuit based on position information of the object to be heated detected by the sensor.

13. The radio wave irradiation device according to claim 12, wherein the control circuit is configured to control the drive circuit so that the radio waves reflected by the radio wave reflecting device are directed toward the object to be heated detected by the sensor.
